(19) United States
(12) Patent Application Publication
(10) Pub. No.: US 2008/0301953 A1
(43) Pub. Date: Dec. 11, 2008

(54) CUTTING GUIDE SYSTEM AND METHOD

(75) Inventor: Jesse Cogswell, Torrance, CA (US)

Correspondence Address: KNOBBE MARTENS OLSON & BEAR LLP, 2040 MAIN STREET, FOURTEENTH FLOOR, IRVINE, CA, 92614, US

(73) Assignee: Gemini Saw Company, Inc., Torrance, CA (US)

(21) Appl. No.: 12/023,949

(22) Filed: Jan. 31, 2008

Related U.S. Application Data
(60) Provisional application No. 60/898,459, filed on Jan. 31, 2007.

(51) Int. Cl. B23D 59/00; B27B 13/00; C03B 19/00; G01B 3/14

(52) U.S. Cl. 30/371; 30/380; 65/70; 33/562

(57) ABSTRACT

Guides for ring saws and ring saws incorporating them and template systems are provided. The guides can be circular, square, rectangular or portions thereof. The system can comprise a guide and a template. The template can be configured to be placed onto a workpiece in a fixed relation relative to the workpiece. The template has an edge along which a side edge of the guide can travel. The guide is attachable to a platen of the ring saw and can include an insertion channel and a blade aperture for allowing passage of a blade of the ring saw during attachment of the guide to the platen. The guide and the template can be sized and configured such that the side surface of the guide can contact the edge of the template for allowing the guide to be moved along a desired cut path to quickly and easily create a precise cut.

### CROSS-REFERENCE TO RELATED APPLICATIONS

This application claims the benefit of U.S. Provisional Application No. 60/898,459, filed Jan. 31, 2007, the entirety of which is incorporated herein by reference.

### BACKGROUND

1. Field of the Invention

The present invention relates generally to ring saws and, more specifically, to cutting guides and related systems for ring saws, ring saws incorporating such guides and template systems that can enable a ring saw to reliably cut precise desired geometric and freeform shapes into a work piece.

2. Description of the Related Art

Various procedures and apparatus have been employed to make specific geometric cuts in materials, such as sheet, glass sheets and other hard materials, such as tile and stone. Some of the devices that have been used include jigsaws, ring saws, water jet cutters, routers, and drills. These types of devices generally allow the user to cut out a desired amount of material from the sheet in a specified shape. However, many of these devices have certain drawbacks, such as cost, ease of use, and limitations on the precision of the cut. Therefore, depending upon the application for which the cutting device will be used, one must carefully consider the implications of selecting one type of cutting device over another.

When working with flat glass, such as that used in shower doors, mirrors, countertops, and the like, for interior decoration and construction, one must select a cutter that allows the user to create precise geometric shapes without chipping and otherwise damaging the work piece. For example, a notch may need to be created in the side of the mirror or glass door in order to prepare the mirror or door for use by providing a suitable location to mount hinges or the like. According to prior art methods, the notch is created by drawing the notch on the mirror and using a cutting device to cut along the drawn pattern. A cutting device such as a router can be used. However, a router can be considerably less effective for the following reasons.

A diamond router uses rotational motion to grind away material, and it cuts in the same plane in which it rotates. As a result, routers tend to circulate ground material sometimes as much as 360 degrees around the router bit, which can cause a great deal of heat and inefficiency in the cutting process. Further, a router bit typically must remove a significant amount of material when compared to what a ring saw must remove in order to perform the desired cut. In fact, it is noted that a one-quarter inch router bit must remove 0.063 square inches of material to progress one inch. However, routers have the advantage of being able to follow a very precise path and create a generally accurate cut.

Despite the accuracy of a router, a ring saw tends to be a better solution for cutting the above-mentioned materials. It is noted that a ring saw can only usually cut at 90 degrees to its rotational plane and has various other disadvantages. However, when compared to a router, a ring saw needs to only remove 0.018 square inches of material to progress one inch.

Additionally, the ring saw would be advantageous when compared to a router because ring saws can make 3,061.5 square inches of contact per minute, while routers can only make 1,397 square inches of contact per minute. As a result, ring saws generally create less heat and provide a faster rate of cutting. Therefore, it would be advantageous to use a ring saw in an application such as cutting mirrors, shower doors, and the like, if the ring saw could be used in a process to accurately cut the material.

The current process for creating a generally rectangular notch using a radial wet saw requires the user to map out the notch, drill one-half inch holes at the inner corners of the rectangle, and use the ring saw to make the cuts between the edges of the work piece and the holes. In order to create the holes, the user must map out the notch, drill the holes at the inner corners of the rectangular pattern half-way through on one side, flip the mirror to the other side, map out the notch again, and drill holes at the inner corners of the rectangular pattern all the way through the mirror. As such, the holes drilled on one side would meet up with the holes drilled on the other and create a hole all the way through the mirror.

The saw is used to cut from the edge of the mirror to the first hole, and then from the first hole to the second hole, and finally from the second hole to the other edge of the mirror in order to create a rectangular cut-out pattern. After the cut is finalized and the cut-out is removed, the edges of the notch need to be sanded or polished with an electric sander to smooth out the flaws, especially at the transitions points between the saw cut line and the holes. In general, this process can sometimes take an hour to accomplish from start to finish.

Therefore, there is a need in the art for a saw that can be utilized to create precise geometric cuts in mirrors, glass sheets, and the like, especially large pieces or sheets of such materials. Further, there is a need in the art for a saw that can allow the user to readily create accurate cuts and that reduces the time and labor required to make such cuts. Finally, there is generally a need in the art to improve the speed and accuracy of cuts in sheet materials and to provide an apparatus for doing so in a cost-effective and efficient manner.

### SUMMARY

According to the invention there is provided a cutting guide for a ring saw. The guide can have a guide body with a bottom surface, at least one side surface, and a guide body periphery. The guide body can define a thickness and a width. The guide body also can have an insertion channel and a blade aperture. The insertion channel can extend outwardly from the blade aperture toward the side surface for allowing a blade to be passed from outside the guide body periphery toward the blade aperture. The blade aperture can be sized and configured to allow the blade to move therethrough. In an embodiment, the guide comprises a generally plate-shaped member having a peripheral or side surface shaped for a desired cut, such as a curve or straight line. Thus, the guide may be generally circular, rectangular, square, or a portion thereof.

Preferably, the guide comprises a circle or a portion thereof. More preferably, the periphery comprises about 45° to 360°, such as about 180° to 360°. It should be understood that the shape of the guide is defined by reference to being viewed from above the saw to which it attached or is a component thereof and the direction of cutting the work piece. Thus, for example, a 180° guide extends in a half circle symmetrically about the blade and forward of the direction of cut.

In another embodiment, the guides of the invention comprises a cut from a periphery to an inner location where there is provided an opening for the ring blade to pass. In some embodiments, the opening will be located at the center of the guide and/or at a position equidistant from the peripheral portions of the guide that are used to determine the shape cut fin or from the work piece. Advantageously, the hole for the blade can be larger than that needed to allow the blade to pass therethrough, so as to permit a user to see where the blade is cutting the work piece.

The guides may be made from any suitable material. Stainless steel is preferred. Preferably the guides will be about 1 to 3 inches wide, more preferably about 1 to 2 inches wide. When the guide is an attachment it is preferably about 1/16 to 5/16 inches thick, more preferably about ⅛ inch thick.

The guide may be a separate component attachable to the ring saw or may be an integral part of the platen or foot of the saw. The attachment approach is preferred as it provides more versatility to the saw. A commercially available saw may therefore be made more versatile by the use of an accessory guide cutting device according to the invention. Such an accessory may be attached to the underside of the platen or foot stabilizer of the ring saw by suitable attachment devices, such as screws, bolts or the like. In order to avoid interference with or scratching the work piece, the underside of the guide is preferably flush with any attachment devices that are inserted from beneath the guide being countersunk into the guide.

In an embodiment, a cutting guide is provided for facilitating the cutting of a workpiece. The guide can comprise a guide body, a hole, an insertion channel, and a fastening element. The guide body can define a bottom surface, at least one side surface and an outer perimeter. The guide body can define a thickness and a width. The side surface can be configured to be positioned against a guide surface of a template to facilitate movement of the guide relative to the template for performing a cut in the workpiece along a cut path. The hole can be disposed through the guide body. The hole can define a diameter greater than a diameter of a ring saw cutting blade. The hole can be located at a given distance from a given point along the outer perimeter of the guide body. The given distance of the hole from the outer perimeter of the guide body can define the cut path. The insertion channel can extend from the hole to the outer perimeter of the guide body. The insertion channel can be configured to facilitate passage of the ring saw cutting blade from outside the guide body periphery toward the hole of the guide. The fastening element can be used for attaching the guide to a ring saw.

In some embodiments, the guide body can define a circular outer perimeter. The hole can be centered relative to the circular outer perimeter of the guide body. The insertion channel can extend linearly from the hole to the outer perimeter of the guide. The fastening element can be formed separately from the guide body and comprises at least one screw. The guide body can include a countersink such that the at least one screw is flush with the bottom surface of the guide body. The bottom surface of the guide body can be planar. The side surface of the guide body can be oriented perpendicularly relative to the bottom surface thereof.

Suitable saws to which the guide of this invention may be attached or incorporated include those sold under the brand name Taurus 3 by Gemini Saw Company of Torrance, Calif. The ring saw is usually handheld. This permits using a relatively low cost saw that is convenient, compact and easy to use. Suitable blades are annular and may either be generally rectangular, oval or circular in cross section. Omni directional blades, especially those that are generally round in cross section are preferred, because they permit cutting in any direction.

The invention also provides an improved method of cutting hard materials such as tile stone or glass and in particular such materials in sheet form. The methods of the invention preferably are addressed to the cutting of glass sheet, such as shower doors and the like. Shower doors must have hinges to mount them to walls. This typically involves a cutout that is generally rectangular or in the shape having initially straight parallel side terminating in a curve joining said sides. This is a difficult shape to cut with conventional cutting means. The guide of the invention permits such a shape to be cut quickly and accurately and with a hand-held saw. According to the invention there is also provided a method of cutting a hard material work piece, such as tile, stone or glass, which comprises applying to the work piece a template having an outline corresponding to the desired shape to be cut from the work piece, cutting from the work piece the desired cut out by means of a ring saw having a cutting guide according to the invention. More particularly, the guide comprises a substantial portion of a circle, such as a disc having a periphery of from about 180° to about 360° about the axis of travel of the ring saw blade.

One embodiment of the invention provides a method of using a hand held ring saw. Thus, the saw is taken to the work piece, rather than bringing the work piece to a conventionally mounted ring saw. This permits the cutting of relatively large, heavy or thick work pieces. For example, the methods of the invention are applicable to work pieces that have a dimension of about 18 inches or more, such as 24 inches or more, such as 8 feet by 4 feet, and the like. The work pieces may be at least ½ inch thick.

In accordance with an embodiment of the method, the method can comprise the steps of: mounting a template relative to the workpiece, the template comprising a recess and a guide surface defined by the recess, at least a portion of the workpiece being exposed in the recess of the template; positioning a ring saw relative to the template with a side surface of a cutting guide being disposed against the guide surface of the template, the guide defining the side surface, an outer perimeter, a hole and a slot extending from the hole to the outer perimeter of the guide, the guide being attached to the ring saw with a ring blade thereof being disposed through the hole of the guide, the hole defining a diameter greater than a diameter of the ring blade, the hole being located at a given distance from a given point along the outer perimeter of the guide; driving the ring blade for making a cut in the workpiece; and moving the ring saw and guide relative to the template with the side surface of the guide contacting the guide surface of the template, the movement of the guide relative to the template defining a cutting path. In another embodiment of the method, the ring saw can be hand-held. In yet another embodiment of the method, the method can be applied to cutting a glass shower door for creating an engagement notch whereat a hinge can be mounted to the door.

According to an embodiment, there is provided a guide and template system for use with a cutting device, such as a ring saw. The system can comprise a guide and a template. As discussed herein, the system can enable a user to create precise and accurate cuts in materials, such as glass, rock, and the like without requiring post-cut operations, such as sanding or polishing. Further, embodiments of the system can allow a user to save in not only time and labor costs, but can further allow the user a much more economical alternative to expensive machinery, such as CNC equipment.

In accordance with an embodiment, the system can comprise a ring saw including a ring blade and a platen fastened to a cutting portion of the ring saw. The ring saw can be configured to rotate the ring blade for driving the ring blade to make a cut in the workpiece. The platen can include an attachment surface and a gap that can be configured to allow the ring blade passage therethrough. The cutting guide can define an outer perimeter, a hole and a slot extending from the hole to the outer perimeter of the guide. The guide can be attachable to the ring saw with the ring blade being passable through the slot to be disposed through the hole of the guide. The hole can define a diameter greater than a diameter of the ring blade and can be located at a given distance from a given point along the outer perimeter of the guide. The outer perimeter of the guide can be configured to be positioned against a guide surface of a template to facilitate movement of the guide relative to the template for performing the cut in the workpiece approximately at the given distance from the guide surface of the template.

In some embodiments of the system, the guide can be attached to the attachment surface of the platen of the ring saw. Further, the guide can be attached to the platen using at least one screw. The guide can include a countersink such that the at least one screw is flush with a bottom surface of the guide. The platen can be a foot stabilizer fixedly attached to the ring saw. Additionally, in accordance with some embodiments, the guide can define a circular outer perimeter. Further, the hole can be centered relative to the circular outer perimeter of the guide. Finally, the guide can be configured such that the slot extends linearly from the hole to the outer perimeter of the guide.

The template can define a lower face and at least one edge. The template can be fastenable to a work piece with the lower face of the template being configured to be positioned adjacent a top surface of the work piece. The edge of the template can be sized and configured such that the side surface of the guide can contact the edge of the template for allowing the guide to be moved along a desired cut path. The template can thereby enable the blade to cut along the desired cut path with the bottom surface of the guide contacting the top surface of the work piece and the blade being activated.

It will be apparent that various features of the guides herein may be combined, to the extent they are compatible.

In another aspect of the invention there is provided a kit comprising one or more accessories for a ring saw, the accessory kit comprising a guide according to the invention. Preferably, the accessory kit comprises a guide according to the invention and one or more other devices to assist cutting shapes in a work piece. Another aspect of the invention provides a kit comprising ring saw and a guide according to the invention.

In an embodiment of the kit, the kit can comprise a cutting guide and a template. The guide can define an outer perimeter, a hole and a slot extending from the hole to the outer perimeter of the guide. The guide can be attachable to a ring saw with a ring blade of the ring saw being disposed through the hole of the guide. The hole can define a diameter greater than a diameter of the ring blade an can be located at a given distance from a given point along the outer perimeter of the guide. The template can be mountable relative to the workpiece. The template can comprise a recess and a guide surface defined by the recess. The guide surface can be configured such that the outer perimeter of the guide is positionable against the guide surface to facilitate movement of the guide relative to the template for performing a cut in the workpiece along a cut path.

In some embodiments of the kit, the guide can define a circular outer perimeter. Further, the hole can be centered relative to the circular outer perimeter of the guide such that a cut path generally follows the guide surface of the recess. The slot can extend linearly from the hole to the outer perimeter of the guide. The guide can be attached to a platen of a ring saw using at least one screw. Further, the guide can include a countersink such that the at least one screw is flush with a bottom surface of the guide. The template can extend beyond an edge of the workpiece for facilitating alignment of the guide relative to the template and the workpiece.

### BRIEF DESCRIPTION OF THE DRAWINGS

The above-mentioned and other features of the inventions disclosed herein are described below with reference to the drawings of the preferred embodiments. The illustrated embodiments are intended to illustrate, but not to limit the inventions. The drawings contain the following figures:

FIG. 1A is a perspective view of a prior art stationary ring saw mounted to a table.

FIG. 1B is a perspective view of a prior art hand-held ring saw.

FIG. 2A is a perspective view of a guide and template system for use with a hand-held cutting device, such as a ring saw, according to an embodiment.

FIG. 2B is a top plan view of the template of the system shown in FIG. 3.

FIG. 3A is a perspective view of the guide of the system, according to an embodiment.

FIG. 3B is a side view of the guide illustrated in FIG. 3A.

FIG. 3C is a top plan view of the guide illustrated in FIG. 3A.

FIG. 4A is bottom perspective view of a ring saw with a guide of the system being attached to a platen of the ring saw.

FIG. 4B is a partial side view of the ring saw illustrated in FIG. 4A illustrating the interconnection of the guide to the platen, according to an embodiment.

FIG. 5A is a top plan view of an alternative embodiment of the guide.

FIG. 5B is a top plan view of another alternative embodiment of the guide.

FIG. 5C is a top plan view of yet another alternative embodiment of the guide.

FIG. 6A is a top plan view of a template, a work piece, a guide, and a desired cut path, according to an embodiment.

FIG. 6B is a top plan view of a template, a work piece, a guide, and a desired cut path, according to another embodiment.

FIG. 6C is a top plan view of a template, a work piece, a guide, and a desired cut path, according to yet another embodiment.

### DETAILED DESCRIPTION OF THE PREFERRED EMBODIMENT

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein.

According to an embodiment of the present inventions, there is provided a unique solution to accomplish the goal of cutting precise geometric shapes and exact free forms in glass mirror stone and similar materials. As discussed above, one of the preferred cutting devices for cutting such materials is a ring saw. Accordingly, some of the embodiments discussed herein can be utilized with a ring saw. Not only will such embodiments tend to enhance the accuracy and precision of the cut, but these embodiments also allow a user to perform a cut in much less time than as previously possible with other cutting devices.

Therefore, there is provided a guide and template system for use with a cutting device, such as a ring saw. The system can be configured to include a guide that can be sized and configured to be mounted onto a platen of the ring saw. Further, the ring saw can be a portable hand-held device that allows the user to move the ring saw with respect to a generally stationary work piece, such as a sheet of glass, stone, or other material. Additionally, the system can include a template that can have an edge that is sized and configured to accommodate the guide for moving therealong. Accordingly, a side surface of the guide can contact the edge of the template in order to create a guide-follower or master-slave relationship that allows the guide to move along a desired cut path.

In some embodiments, the template can define a recess having an interior area. The guide can be configured to move within the interior area while contacting the edge and moving along the desired cut path.

In other embodiments, the template can be configured such that the edge runs along an exterior periphery thereof such that the side surface of the guide can contact the edge of the template to create a guide-follower relationship through which the guide can pass along a desired cut path that is disposed exterior to the template.

Thus, in embodiments wherein the guide is utilized in conjunction with a ring saw, the guide can be configured to include a channel and aperture through which the ring saw blade can pass in order to facilitate the cutting of the work piece. Although other cutting devices can be utilized, it is contemplated that the ring saw can provide the fastest and most accurate cut for various geometric shapes. In particular, because the ring saw can cut not only in a forward and backward, but side-to-side and diagonal directions, and due to the relatively minimal amount of material that a ring saw blade must remove in performing a cut, the ring saw is a preferred cutting device for use with embodiments disclosed herein.

In implementing some embodiments, it is contemplated that the guide and template should be sized and configured to correspond to the desired cut path. In some embodiments, the template can be adjustable so as to allow the user to modify the width and length of the recess. Further, it is contemplated that the system can include template components that can be interchangeably secured to the template to alter the size and/or shape of the recess for allowing the user to create a variety of possible cut paths. Such components can include, for example, a radius corner piece that can fit to within a corner of a rectangular recess and that change the corner from a right angle to a smooth curve. Other various configurations will be apparent to one of skill in the art based upon the present disclosure.

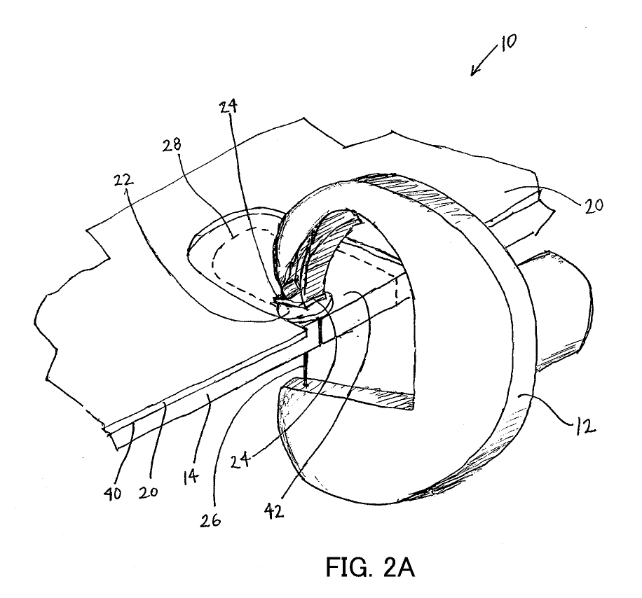

Referring now to the drawings wherein the showings are made for purposes of illustrating preferred embodiments of the present inventions, and not for purposes of limiting the same, FIG. 2A is a perspective view of a guide and template system 10 being utilized in conjunction with a ring saw 12 in order to create a cut through a work piece 14. The system can include a template 20 and a guide 22. As illustrated in the embodiment of FIG. 2A, the guide 22 can be secured to a platen 24 of the ring saw 12 and can be sized and configured to correspond to the configuration of the template 20 so as to enable a blade 26 of the ring saw 12 to pass along a desired cut path 28 to thereby perform a cut in the work piece 14. As discussed herein, embodiments of the system 10 can be utilized to create precise cuts that require little, if any, polishing, reshaping, or other post-cut forming operations.

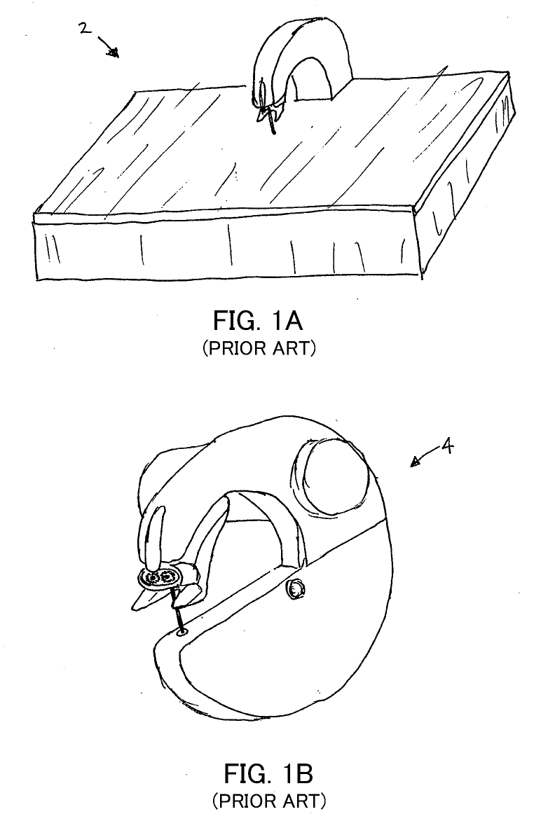

As described generally above, prior art ring saw devices, such as those shown in FIGS. 1A-1B, have various disadvantages when precise cuts must be made. Such devices only include a platen or work table against which the user can support the workpiece while performing the cut. Often, the platen does not function to provide a stable surface against which to rest the ring saw; instead, the platen functions in mostly in a protective capacity.

Further, if a ring saw device was stationary, the user would have been required to move the entire work piece in relation to the blade of the ring saw device in order to perform the cut. Otherwise, if the ring saw device were hand-held, the user would have been required to move the ring saw in relation to a stationary work piece in order to perform the cut. In either scenario, the accuracy of the cut would be determined by the steadiness and precision of the user. Frequently, the user would be unable to cut an acceptable straight line or to accurately follow a curve.

Furthermore, as mentioned above, in some cases, certain cuts would require the user to drill holes into the work piece prior to using the ring saw device; in these cases, after making the cut by moving the blade from the edge of the work piece toward the holes as described above, the user would need to smooth out the edges and protrusions left at the transition points between the drilled holes and the cut. Therefore, each of these scenarios illustrates that the user of prior art cutting devices, such as the ring saw devices, must not only rely on their own steady hand to create accurate cuts, but as a result of inaccurate cuts, must frequently correct the cuts by post-cut procedures, such as sanding, polishing, and the like.

In contrast to the difficulty provided by the prior art cutting devices, embodiments of the system 10 can enable the user to create an accurate cut along a desired cut path. As shown in FIGS. 2A and 2B, the cut path 28 can be geometrically defined by its relationship to an edge 32 of the template, whether along the exterior of the template 20 or within a recess 30 of the template 20. For example, as shown in FIG. 2B, the recess 30 can define an interior surface 50, and the desired cut path 28 can be offset from the edge 32 or interior surface 50. As shown in the top view of FIG. 2B, the desired cut path 28 can include straight lines and curves; however, the desired cut path can be any variety of geometric shapes, as required by the user. As described below, the desired cut path 28 generally corresponds to the edge 32 of the recess 30.

Referring still to FIGS. 2A and 2B, the template 20 can be fastenable to the work piece 14 by using various fastening means. Such fastening means can include clamps, such as C-clamps, bolts and mechanical fasteners, and adhesives, just to name a few. Further, it is contemplated that the template 20 can be integrally formed with a work table whereupon the user can place and fasten the work piece 14. Thus, the work piece 14 and the template 20 can maintain a fixed relationship without being directly fastened to each other. Whether fastened to each other directly or indirectly fixed in relationship to each other, embodiments of the system 10 can be beneficially used.

The template 20 can define a lower face 40 that can be positioned adjacent a top surface 42 of the work piece 14. In some embodiments, the work piece 14 defines a generally planar or plate-shaped body whereupon the template 20 can be placed. Thus, the lower face 40 of the template 20 can be sized and configured to correspond to the planar configuration of the work piece 14. However, in other embodiments, it is contemplated that the lower face 40 of the template 20 can also be configured to have a generally concave or convex shape or otherwise in order to generally complement the shape of the top surface 42 of the work piece 14. Although a generally complimentary relationship may not be essential in order to implement embodiments of the system 10, it may be preferable in order to facilitate accurate cutting and to reduce potential negative interactions between the guide 22 and the template 20.

In accordance with another embodiment, the template 20 can be sized and configured such that the guide 22 and the template 20 interact in a guide-follower or master-slave relationship. This relationship can refer to the ability of the guide 22 to follow a path generally defined by the geometric configuration of the template 20. In this regard, the template 20 can act as the guide or master and the guide 22 can act as the follower or slave. This general relationship enables the user to create a template of a specific size and shape that can correspond to the guide 22 and the desired cut path 28. Furthermore, as shown in FIGS. 2A and 2B, the template 20 can be configured to extend beyond an edge of the work piece 14 in order to aid the user in aligning the guide 22 with the desired cut path 28.

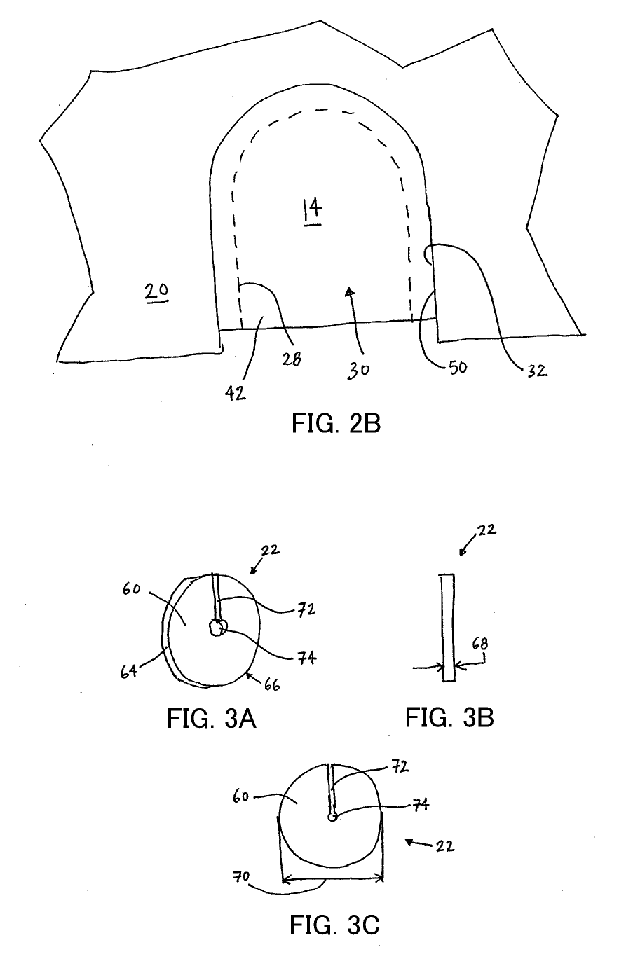

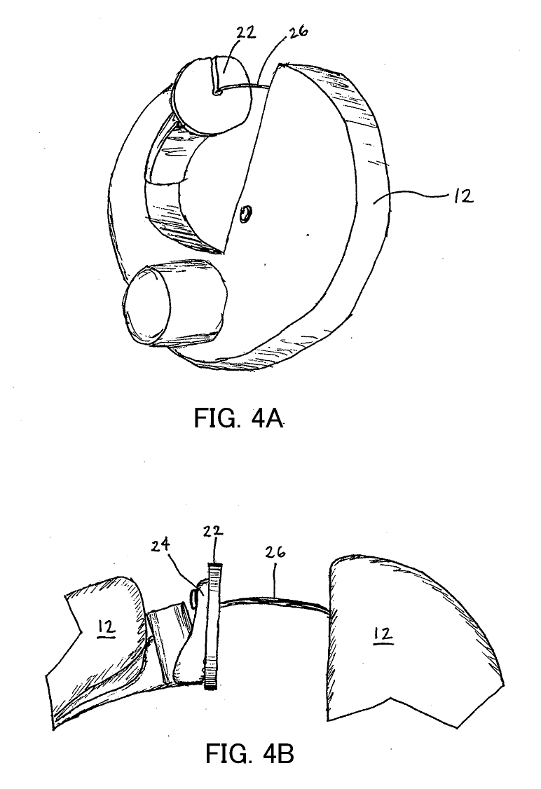

Referring now to FIG. 3A, an embodiment of the guide 22 is shown in a perspective view. The guide 22 can have a guide body 60 with a bottom surface 62, at least one side surface 64, and a guide body periphery 66. As shown in FIGS. 3B and 3C, which are respectively a side view and a bottom plan view of the guide 22, the guide body 60 can define a thickness 68 and a width 70. In the embodiment illustrated in FIG. 3C, the width 70 of the guide body 60 is also equal to the diameter of the circular guide body periphery 66. As will be discussed below, the width 70 should preferably be taken into account when determining the desired cut path 28.

Although the bottom surface 62 of the guide 22 is illustrated as being substantially planar, it is contemplated that the bottom surface 62 can be otherwise shaped in order to allow the user to cut a bevel. For example, the bottom surface 62 can be generally slanted for simple bezels. However, the bottom surface 62 can also have a conical configuration so as to allow the user greater control over the shape and form of the bezel. Other modifications and configurations will be apparent to those of skill in the art.

The guide 22 can be made from a variety of materials, such as metals, plastics, and other materials that are generally rigid and do not exhibit excessive wear as a result of rubbing with other materials. In some embodiments, the guide 22 can be made from stainless steel, while in other embodiments, the guide 22 can be made from a plastic such as polyethylene which exhibits little wear and creates relatively little friction when in contact with other materials and would not tend to harm the blade should the blade contact the guide 22.

As illustrated in FIGS. 3A and 3C, an embodiment of the guide 22 can be configured with the guide body 60 including an insertion channel 72 and a blade aperture 74. The insertion channel 72 can extend outwardly from the blade aperture 74 toward the side surface 64 of the guide body 60. In the embodiment illustrated in FIGS. 3A and 3C, the insertion channel 72 is illustrated as being substantially linear; however, the insertion channel can be curvilinear or otherwise shaped. In this regard, the insertion channel 72 is preferably sized and configured to allow the blade 26 to be passed from outside the guide body periphery 66 toward the blade aperture 74. Thus, the channel 72 extends throughout the thickness 68 of the guide body 60.

In addition, the blade aperture 74 is preferably sized and configured to allow the blade 26 to move therethrough. The blade aperture 24 should be just wide enough so that the blade 26 does not erode it during the cutting process. As discussed below, the blade aperture 24 can, in some embodiments using the ring saw 12, be as small as 0.25 inches in diameter. Further, the size and configuration of the insertion channel 72 and the blade aperture 74 preferably ensure that any material cut from the work piece 14 is able to be removed easily therefrom in order to ensure that such material does not build up between the bottom surface 62 of the guide 22 and the top surface 42 of the work piece 14. Furthermore, in embodiments where the user uses the system 10 in conjunction with a ring saw, the user should ensure that the blade 26 of the ring saw 12 is moving in a direction downward through the work piece 14 and away from the guide 22.

Referring again to FIGS. 3A-3C, in an embodiment wherein the system 10 is used with the ring saw 12, it is noted that the preferred shape for the guide 12 is a circle. This is due to the fact that the cross-section of the blade 26 is round and a circle can be placed around the blade 26 in a concentric fashion. For example, by using a circular guide 22 around the blade 26 of a typical “Taurus 3” ring saw, whose blade has a 0.072 inch diameter in its cross-section and is formed in a large ring having a 5.75 inch diameter. Accordingly, a preferred embodiment of the guide 22 would have a thickness ⅛ inch and a width 70 (or diameter in such a circular embodiment) of 1.572 inches. Further, the blade aperture 74 of such an embodiment is 0.25 inch in diameter and the width of the insertion channel 72 is ⅛th inch. In this embodiment, the use of a blade 26 with a 0.072 inch diameter generally removes that amount or width of material from the work piece 14. Due to the thickness 70 (or diameter in such a circular embodiment) of the guide 22 (which is circular in this embodiment), the offset is a radius of 0.75 inch, which is one-half of the thickness 70 or diameter less the diameter of the blade 26. Such a configuration of this embodiment can allow the user to easily and quickly calculate the necessary configuration for corresponding template 20 in order to achieve a desired cut path 28.

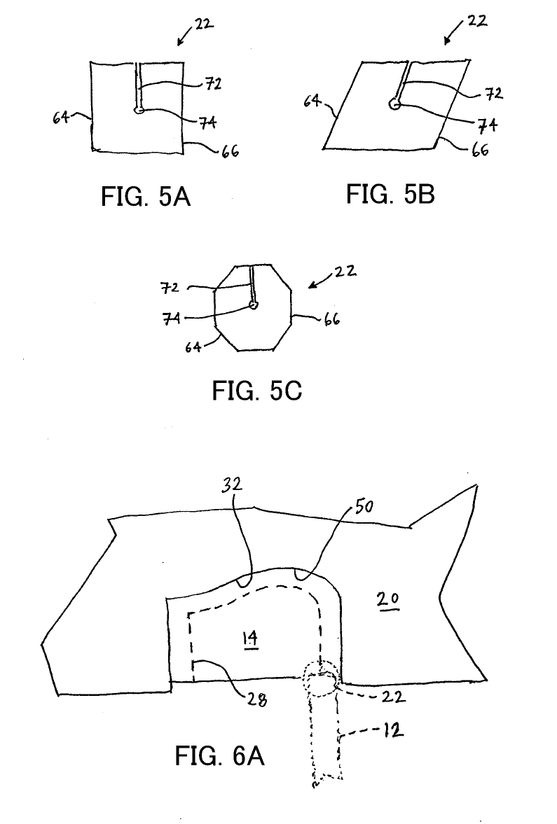

One of the advantages of using a guide 22 that has a circular guide body periphery 66 is that the user can approach and change the angle of cutting without changing the distance of the blade 26 from the template 20. Nevertheless, as shown in FIGS. 5A-5C, various other configurations of the guide body periphery 66 can be used. For example, FIG. 5A illustrates a generally square guide body periphery 66. FIG. 5B illustrates a guide body periphery 66 that is generally shaped as a parallelogram. FIG. 5C illustrates that the guide body periphery 66 can be shaped as an octagon.

Certainly, the intended use of the guide 22 can determine which shape the guide body periphery 66 should preferably have. For example, as noted above, straight lines and curves can be easily cut with a guide body periphery 66 that is circular. However, where the desired cut path 28 includes a series of line segments that are not curvaceous, a regular polygon can also be used. As would be understood by one of skill in the art, when the guide body periphery 66 is shaped as a regular polygon, it may be preferable that the regular polygon include as many sides as necessary to follow the desired cut path 28 as precisely as possible. For example, if the desired cut path 28 is composed of several straight-line segments, the angular orientation of the segments could be considered when determining how many sides the regular polygon should have. Assuming that the blade 26 passes through a centralized location of the guide body 22, that the blade 26 can be spaced from each side of the regular polygon at an equal distance, the guide path 28 can be offset from the edge 32 of the template 20 corresponding to and allow the user to perform a precise and accurate cut.

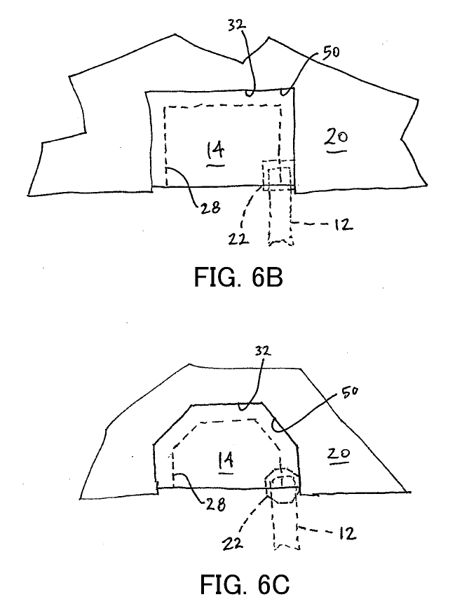

These principles are illustrated in exemplary embodiments shown in FIGS. 6A-6C. FIG. 6A is a top plan view of the work piece 14, the template 20, and the guide 22. In FIGS. 6A-6C, the ring saw 12 is illustrated in hidden lines. Referring to FIG. 6A, the bottom surface 62 of the guide plate 22 can first be placed in contact with the top surface 42 of the template 14. Further, the side surface 64 of the guide 22 can be placed in contact with the interior surface 50 of the template 20. Preferably, the guide 22 and the template 20 are both sized and configured such that their respective thicknesses at the side surface 64 and the interior surface 50 allow the guide 22 to pass along the edge 32 or the interior surface 50 of the recess 30 in a stable manner.

Thus, in use, the user would be able to exert a substantial amount of force in pressing the guide 22 against the edge 32 or the interior surface 50 of the template 20. For example, in a preferred embodiment, the side surface 64 of the guide 22 and the edge 32 or the interior surface 50 of the template 20 can be generally flat surfaces that are oriented perpendicularly with respect to the top surface 42 of the work piece 14. Further, it is contemplated that the guide 22 can have a circumferentially extending band, which can be shaped as a “V”, which can be received into a notch formed along the edge 32 or the interior surface 50 of the template 20. In such an embodiment, the band could engage the notch in order to further stabilize the guide 22 and ring saw 12 during the cutting process.

As shown in FIG. 6A, and as discussed above, the desired cut path 28 can be offset from the edge 32 or interior surface 50 of the template 20 by a distance corresponding to a dimension of the guide 22. In the embodiment illustrated, the offset of the desired cut path 28 corresponds to the radial distance from the side surface 64 to the surface of the blade 26 passing through the blade aperture 74. In the embodiment illustrated in FIG. 6A, the offset is substantially the same along the entire desired cut path 28. Thus, in using the system 10, the user can create a precise and accurate curvilinear cut along the desired cut path 28. This is performed by maintaining the side surface 64 of the guide 22 against the interior surface 50 of the template 20 and moving the blade 26 in the direction of the desired cut path 28. Consequently, the cut can be easily, quickly, and precisely made by the user.

In the embodiment illustrated in FIG. 6B, the system 10 includes a guide 22 that is generally square in shape and corresponds to a generally square recess 30 of the template 20. FIG. 6C illustrates yet another embodiment of the system 10 wherein the desired cut path 28 includes a plurality of segments in which adjacent segments are oriented at 135 degrees with respect to adjacent segments. In such an embodiment, it may be preferable to utilize a guide 22 that is shaped as a regular octagon. However, as will be noted by one of skill in the art, embodiments in which the guide 22 is not shaped as a circle increase the possibility that the desired cut path 28 may not be followed. Specifically, it is preferable that the guide 22 provide only one point of contact on its side surface 64 that corresponds to the desired amount of offset from the edge 32 or the interior surface 50 of the template 20. Therefore, the circle is the most preferable shape, although other shapes can be used and can provide precision and accuracy.

Further, it is contemplated that the system 10 can include template components that can be interchangeably secured to the template 20, whether exterior to the edge 32 or to the interior surface 50 of the template 20, to alter the size and/or shape of the edge 32 or the recess 30 for allowing the user to create a variety of possible cut paths. Such components can include, for example, a radius corner piece that can fit to within a corner of a rectangular recess and that change the corner from a right angle to a smooth curve. Other various configurations will be apparent to one of skill in the art based upon the present disclosure.

Further to the general usage of the system 10 as discussed above, the general procedure for using the system 10 with the ring saw 12 would entail the following steps. First, the work piece 14 can be laid out and the desired cut path 28 can be calculated by considering the dimensions of the desired cut. In embodiments of the system 10 where the template 20 is adjustable, the user should also consider the configuration of the guide 22 and thereby calculate the needed offset and the needed configuration of the template 20. However, in embodiments where the template 20 is not adjustable, it is contemplated that an appropriately sized guide 22 can be selected from a plurality of guides, which may be incorporated in a guide set.

Once the template 20 and the guide 22 are appropriately selected and configured, the template 20 is placed in fixed relation to the work piece 14. As mentioned above, this may be accomplished by mounting the template 20 directly to the work piece, or by securing the template 14 to a table to which the template 20 is secured. Thus, by either direct or indirect means, the work piece 14 and the template 20 would now be appropriately arranged.

With the setup completed, and the guide plate 22 attached to the platen 24 of the ring saw 12, the ring saw can be first primed with water and the saw is activated. The user should then carefully place a forward portion of the bottom surface 62 of the guide 22 flatly against the top surface 42 of the work piece 14. (In such an embodiment, the top surface 42 and the bottom surface 62 can both be generally planar.) Then, the user should carefully move the blade 26 into contact with the work piece 14 and begin performing the cut by moving the blade 26 in the direction of the desired cut path 28 while maintaining the side surface 64 of the guide 22 in contact with the edge 32 or the interior surface 50 of the template 20. Once again, it is noted that although embodiments disclosed herein suggest that the edge 32 relates only to the recess 30 that can be formed within the template 20 according to various embodiments, the edge 32 can equally refer to any edge along the template 20, such as an exterior edge on the outer periphery of the template 20.

After the user has moved the blade 26 along the desired cut path 28, and carefully finished the cut, the resultant cut is very precise and needs little or no sanding or other finishing procedures in order to finalize the cutting process. As a result, the quality of the cut is much higher and the labor time cost factor can be cut by more than half. In fact, there are many industrial applications in which embodiments of the system 10 can cut the time and labor requirements by days.

Furthermore, one of the uses for the system 10 disclosed herein, is for shower door hinges. These special hinges require notches so that shower doors can be installed often without any frame at all. In these applications, the notch must be of a special and particular shape. As such, prior art methods for creating such a notch would require multiple cutting steps depending on the intricacy of the notch. For example, a “mouse ears notch” can require a jig fixture to do a rectangular notch and then require a radius template for creating ears on the left and right sides of the rectangular notch. Typically, such a complicated notch could only be accurately cut using expensive CNC machines that are specifically programmed to cut these notches. Through implementing embodiments of the system 10, it is possible to create such intricate cuts without the need of such expensive equipment and with much less time and labor costs.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A system for cutting a workpiece, the system comprising:
a ring saw including a ring blade and a platen fastened to a cutting portion of the ring saw, the ring saw being configured to rotate the ring blade for driving the ring blade to make a cut in the workpiece, the platen including an attachment surface and a gap, the gap being configured to allow the ring blade passage therethrough; and
a cutting guide defining an outer perimeter, a hole and a slot extending from the hole to the outer perimeter of the guide, the guide being attachable to the ring saw with the ring blade being passable through the slot to be disposed through the hole of the guide, the hole defining a diameter greater than a diameter of the ring blade, the hole being located at a given distance from a given point along the outer perimeter of the guide, the outer perimeter of the guide being configured to be positioned against a guide surface of a template to facilitate movement of the guide relative to the template for performing the cut in the workpiece approximately at the given distance from the guide surface of the template.

2. The system of claim 1, wherein the guide is attached to the attachment surface of the platen of the ring saw.

3. The system of claim 2, wherein the guide is attached to the platen using at least one screw.

4. The system of claim 3, wherein the guide includes a countersink such that the at least one screw is flush with a bottom surface of the guide.

5. The system of claim 2, wherein the platen is a foot stabilizer fixedly attached to the ring saw.

6. The system of claim 1, wherein the guide defines a circular outer perimeter.

7. The system of claim 6, wherein the hole is centered relative to the circular outer perimeter of the guide.

8. The system of claim 1, wherein the slot extends linearly from the hole to the outer perimeter of the guide.

9. A kit for a ring saw cutting apparatus to facilitate the cutting of a workpiece, the kit comprising:
a cutting guide defining an outer perimeter, a hole and a slot extending from the hole to the outer perimeter of the guide, the guide being attachable to a ring saw with a ring blade of the ring saw being disposed through the hole of the guide, the hole defining a diameter greater than a diameter of the ring blade, the hole being located at a given distance from a given point along the outer perimeter of the guide; and
a template being mountable relative to the workpiece, the template comprising a recess and a guide surface defined by the recess, the guide surface being configured such that the outer perimeter of the guide is positionable against the guide surface to facilitate movement of the guide relative to the template for performing a cut in the workpiece along a cut path.

10. The kit of claim 9, wherein the guide defines a circular outer perimeter.

11. The kit of claim 10, wherein the hole is centered relative to the circular outer perimeter of the guide such that a cut path generally follows the guide surface of the recess.

12. The kit of claim 9, wherein the slot extends linearly from the hole to the outer perimeter of the guide.

13. The kit of claim 9, wherein the guide is attached to a platen of a ring saw using at least one screw.

14. The kit of claim 13, wherein the guide includes a countersink such that the at least one screw is flush with a bottom surface of the guide.

15. The kit of claim 9, wherein the template extends beyond an edge of the workpiece for facilitating alignment of the guide relative to the template and the workpiece.

16. A cutting guide for facilitating the cutting of a workpiece, the guide comprising:
a guide body defining a bottom surface, at least one side surface and an outer perimeter, the guide body defining a thickness and a width, the side surface being configured to be positioned against a guide surface of a template to facilitate movement of the guide relative to the template for performing a cut in the workpiece along a cut path;
a hole disposed through the guide body, the hole defining a diameter greater than a diameter of a ring saw cutting blade, the hole being located at a given distance from a given point along the outer perimeter of the guide body, the given distance of the hole from the outer perimeter of the guide body defining the cut path;
an insertion channel extending from the hole to the outer perimeter of the guide body, the insertion channel being configured to facilitate passage of the ring saw cutting blade from outside the guide body periphery toward the hole of the guide; and
a fastening element for attaching the guide to a ring saw.

17. The guide of claim 16, wherein the guide body defines a circular outer perimeter.

18. The guide of claim 17, wherein the hole is centered relative to the circular outer perimeter of the guide body.

19. The guide of claim 16, wherein the insertion channel extends linearly from the hole to the outer perimeter of the guide.

20. The guide of claim 16, wherein the fastening element is formed separately from the guide body and comprises at least one screw.

21. The guide of claim 20, wherein the guide body includes a countersink such that the at least one screw is flush with the bottom surface of the guide body.

22. The guide of claim 16, wherein the bottom surface of the guide body is planar.

23. The guide of claim 16, wherein the side surface of the guide body is oriented perpendicularly relative to the bottom surface thereof.

24. A method for performing a cut in a workpiece using a ring saw, the method comprising:
mounting a template relative to the workpiece, the template comprising a recess and a guide surface defined by the recess, at least a portion of the workpiece being exposed in the recess of the template;
positioning a ring saw relative to the template with a side surface of a cutting guide being disposed against the guide surface of the template, the guide defining the side surface, an outer perimeter, a hole and a slot extending from the hole to the outer perimeter of the guide, the guide being attached to the ring saw with a ring blade thereof being disposed through the hole of the guide, the hole defining a diameter greater than a diameter of the ring blade, the hole being located at a given distance from a given point along the outer perimeter of the guide;
driving the ring blade for making a cut in the workpiece; and
moving the ring saw and guide relative to the template with the side surface of the guide contacting the guide surface of the template, the movement of the guide relative to the template defining a cutting path.

25. The method of claim 24, wherein the ring saw is hand-held.

26. The method of claim 24, wherein the method is applied to cutting a glass shower door for creating an engagement notch whereat a hinge can be mounted to the door.
